(19) United States
(12) Patent Application Publication
(10) Pub. No.: US 2023/0292247 A1
(43) Pub. Date: Sep. 14, 2023

(54) NETWORK CONNECTION METHOD AND APPARATUS, ELECTRONIC DEVICE, AND STORAGE MEDIUM

(71) Applicants: ZHEJIANG GEELY HOLDING GROUP CO., LTD, Hangzhou, Zhejiang (CN); ZHEJIANG LIANKONG TECHNOLOGIES CO., LTD., Ningbo, Zhejiang (CN)

(72) Inventors: Guanming HUANG, Ningbo, Zhejiang (CN); Xin SHANG, Ningbo, Zhejiang (CN)

(21) Appl. No.: 18/013,377

(22) PCT Filed: Jun. 29, 2020
(86) PCT No.: PCT/CN2020/098944

§ 371 Date: Dec. 28, 2022

(51) Int. Cl. H04W 52/02

(52) U.S. Cl. CPC H04W 52/0261

(57) ABSTRACT

Disclosed are a network connection method and apparatus, an electronic device, and a storage medium. The method comprises: if it is detected that a vehicle is in a stalled state, extracting a network frequency point table from a frequency point storage area, wherein the network frequency point table at least comprises one network frequency point, and the network frequency point is acquired and stored in the network frequency point table after the vehicle is started; cyclically searching for each network frequency point in the network frequency point table; determining a current network signal strength corresponding to each network frequency point; determining, according to the current network signal strength corresponding to each network frequency point, a target network frequency point to be connected; and connecting to the target network frequency point, and then performing data interaction.

### FIELD OF THE INVENTION

The present application relates to the field of communication technology, and in particular, to a network connection method and apparatus, an electronic device, and a storage medium.

### BACKGROUND OF THE INVENTION

In the case of weak signal, a mobile communication device often increases transmitting power to find a base station with stronger or even farther signal, thereby avoiding the situation of network disconnection. However, increasing the transmitting power inevitably leads to an increase in power consumption, which is the same as the truth that the power of a mobile phone, which is not turned off in a plane, drops particularly fast.

For a vehicle-mounted communication device, if it adopts a way of the mobile phone for weak signal connection, particularly when the vehicle is parked in a non-network area such as a basement for a long time, a faster power loss of the entire vehicle will be caused, thereby bringing unnecessary trouble to the owner of the vehicle.

### BRIEF DESCRIPTION OF THE INVENTION

The embodiments of the present application provide a network connection method and apparatus, an electronic device, and a storage medium, for saving power consumed by a device on a vehicle searching for a network frequency point before a network connection is made.

In an aspect, an embodiment of the present application provides a network connection method, the method including:

extracting a network frequency point table from a frequency point storage area if it is detected that a vehicle is in a stalled state, where the network frequency point table at least includes one network frequency point, and the network frequency point is acquired and stored in the network frequency point table after the vehicle is started;

cyclically searching for each network frequency point in the network frequency point table;

determining a current network signal strength corresponding to each network frequency point;

determining, according to the current network signal strength corresponding to each network frequency point, a target network frequency point to be connected; and

connecting to the target network frequency point, and then performing data interaction.

Optionally, before extracting a network frequency point table from a frequency point storage area if it is detected that a vehicle is in a stalled state, the method further includes: searching for a network frequency point if it is detected that the vehicle is in a started state; and storing the network frequency point acquired by searching in the network frequency point table.

Optionally, the quantity of the network frequency point in the network frequency point table is preset; and storing the network frequency point acquired by searching in the network frequency point table includes: replacing a historical network frequency point in the network frequency point table with the network frequency point acquired by searching according to a time sequence.

Optionally, cyclically searching for each network frequency point in the network frequency point table includes: cyclically searching for each network frequency point in the network frequency point table according to a preset first time interval.

Optionally, after cyclically searching for each network frequency point in the network frequency point table, the method further includes: if each network frequency point in the network frequency point table cannot be searched, starting the next round of cyclical search for each network frequency point in the network frequency point table based on a preset second time interval.

Optionally, the method further includes: if the round number of the cyclical search reaches a preset round number, searching for the network frequency point according to a preset third time interval to acquire a new network frequency point.

In another aspect, there is provided a network connection apparatus, the apparatus including:

an extraction module, configured to extract a network frequency point table from a frequency point storage area if it is detected that a vehicle is in a stalled state, where the network frequency point table at least includes one network frequency point, and the network frequency point is acquired and stored in the network frequency point table after the vehicle is started;

a connection module, configured to cyclically search for each network frequency point in the network frequency point table;

a first determination module, configured to determine a current network signal strength corresponding to each network frequency point;

a second determination module, configured to determine, according to the current network signal strength corresponding to each network frequency point, a target network frequency point to be connected; and

the connection module, further configured to connect to the target network frequency point, and then perform data interaction.

Optionally, the apparatus further includes: a searching module, configured to search for a network frequency point if it is detected that the vehicle is in a started state; and a storage module, configured to store the network frequency point acquired by searching in the network frequency point table.

Optionally, the quantity of the network frequency point in the network frequency point table is preset; and the storage module is configured to replace a historical network frequency point in the network frequency point table with the network frequency point acquired by searching according to a time sequence.

Optionally, the connection module is configured to cyclically search for each network frequency point in the network frequency point table according to a preset first time interval.

Optionally, the connection module is configured to start the next round of cyclical search for each network frequency point in the network frequency point table based on a preset second time interval if each network frequency point in the network frequency point table cannot be searched.

Optionally, the searching module is configured to search for the network frequency point according to a preset third time interval to acquire a new network frequency point if the round number of the cyclical search reaches a preset round number.

In another aspect, there is provided an electronic device, the electronic device including a processor and a memory, where the memory stores at least one instruction, at least one program, a code set or an instruction set, and the at least one instruction, the at least one program, the code set or the instruction set is loaded and executed by the processor to implement the network connection method.

In still another aspect, there is provided a computer-readable storage medium, the storage medium storing at least one instruction, at least one program, a code set or an instruction set, where the at least one instruction, the at least one program, the code set or the instruction set is loaded and executed by a processor to implement the network connection method.

The network connection method and apparatus, the electronic device, and the storage medium provide by the embodiments of the present application have the following technical effects:

if it is detected that a vehicle is in a stalled state, a network frequency point table is extracted from a frequency point storage area, where the network frequency point table at least includes one network frequency point, and the network frequency point is acquired and stored in the network frequency point table after the vehicle is started; each network frequency point in the network frequency point table is cyclically searched; a current network signal strength corresponding to each network frequency point is determined; a target network frequency point to be connected is determined according to the current network signal strength corresponding to each network frequency point; and the target network frequency point is connected, and then data interaction is performed. In this way, a device on the vehicle may be connected through the network frequency point stored in the network frequency point table, and the network frequency point is acquired during the vehicle traveling, therefore, when parking, the vehicle does not need to consume more power to search for a new network frequency point again, thereby prolonging the operating time of the device when the vehicle is parked, such that a vehicle owner remotely monitors the vehicle by means of a mobile terminal.

### BRIEF DESCRIPTION OF THE DRAWINGS

In order to more clearly illustrate the technical solutions and advantages of the embodiments of the present application or the prior art, the accompanying drawings required in the descriptions of the embodiments or the prior art will be briefly introduced below. Apparently, the accompanying drawings in the following descriptions are only some embodiments of the present application, and those of ordinary skill in the art may still obtain other drawings from these drawings without creative efforts.

FIG. 1 is a schematic diagram of an application environment according to an embodiment of the present application;

FIG. 2 is a schematic diagram of an application environment according to an embodiment of the present application;

FIG. 3 is a schematic flowchart of a network connection method according to an embodiment of the present application;

FIG. 4 is a schematic flowchart of a network connection method according to an embodiment of the present application;

FIG. 5 is a schematic structural diagram of a network connection apparatus according to an embodiment of the present application; and

FIG. 6 is a block diagram of a hardware structure of a server of a network connection method according to an embodiment of the present application.

### DETAILED DESCRIPTION

The technical solutions in the embodiments of the present application are described clearly and completely below in combination with the drawings in the embodiments of the present application. Apparently, the described embodiments are merely a part of the embodiments of the present application, rather than all of the embodiments. On the basis of the embodiments in the present application, all other embodiments obtained by those of ordinary skill in the art without creative efforts fall within a protection scope of the present application.

It should be noted that the terms “first”, “second”, and the like in the specification, the claims, and the drawings of the present invention are used to distinguish between similar objects and not necessarily used to describe a specific sequence or order. It should be understood that data so used are interchangeable under appropriate circumstances, such that the embodiments of the present invention described herein can be implemented in a sequence other than those illustrated or described herein. In addition, the terms “comprising”, and “having” and any variations thereof are intended to cover non-exclusive inclusion. For example, a process, a method, a system, a product or a server including a series of steps or units is not necessarily limited to the explicitly listed steps or units, but may include other steps or units that are not explicitly listed or are inherent to such process, method, product or device.

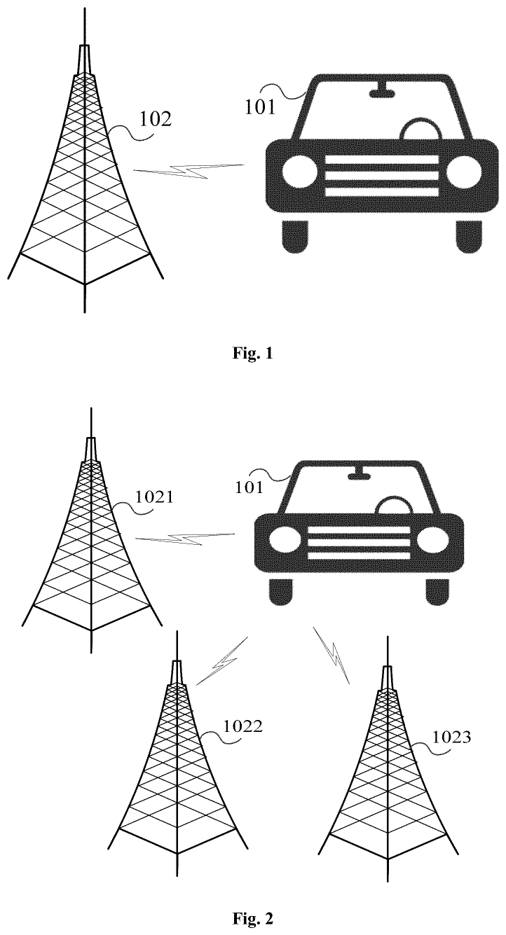

Please referring to FIG. 1 and FIG. 2, FIG. 1 and FIG. 2 are schematic diagrams of an application environment according to an embodiment of the present application, and the schematic diagrams include a vehicle 101 and a base station 102, where the vehicle 101 may be an unmanned vehicle, that is, an autonomous vehicle, or may alternatively be a semi-autonomous vehicle. In an optional implementation, as shown in FIG. 1, there is only one base station 102 within a certain distance from the vehicle, and network frequency points in a network frequency point table are all network frequency points corresponding to the base station. In another optional implementation, as shown in FIG. 2, there may be a plurality of base stations 1021, 1022, and 1023 within a certain distance from the vehicle. Each network frequency point in the network frequency point table belongs to the plurality of base stations.

Based on the schematic diagrams of the application environment, specifically, if a device in the vehicle 101 detects that the vehicle is in a stalled state, a network frequency point table may be extracted from a frequency point storage area of the vehicle 101, where the network frequency point table at least includes one network frequency point, and the network frequency point is acquired and stored in the network frequency point table after the vehicle is started. Then, the device in the vehicle 101 may cyclically search for each network frequency point in the network frequency point table, and then determine a current network signal strength corresponding to each network frequency point. According to the current network signal strength corresponding to each network frequency point, a target network frequency point to be connected is determined, and the target network frequency point is connected, and then data interaction is performed.

In the embodiments of the present application, the device in the vehicle 101 may be at a vehicle-mounted terminal, and further specifically a communication device in the vehicle-mounted terminal, and the following description is provided by using the vehicle-mounted terminal in the vehicle as an example.

A network frequency point is a number for a fixed frequency. A frequency interval is generally 200 KHz, so that the 890 MHz-915 MHz is divided into 125 wireless frequency bands from 890 MHz, 890.2 MHz, 890.4 MHz, 890.6 MHz, 890.8 MHz, 891 MHz . . . 915 MHz according to the frequency interval of 200 KHz, and each band is numbered from 1, 2, 3, 4 . . . 125; these numbers for the fixed frequencies are the network frequency points; or conversely, the network frequency points are numbers for the fixed frequencies. In a GSM network, the frequency is replaced with the network frequency point to specify a transmitting frequency of a transceiver group. For example: a carrier is specified with a frequency point of 3, that is to say, the carrier will receive an uplink signal with a frequency of 890.4 MHz and transmit the signal at a frequency of 935.4 MHz.

In the embodiments of the present application, one base station may correspond to one frequency point, or may alternatively correspond to a plurality of network frequency points.

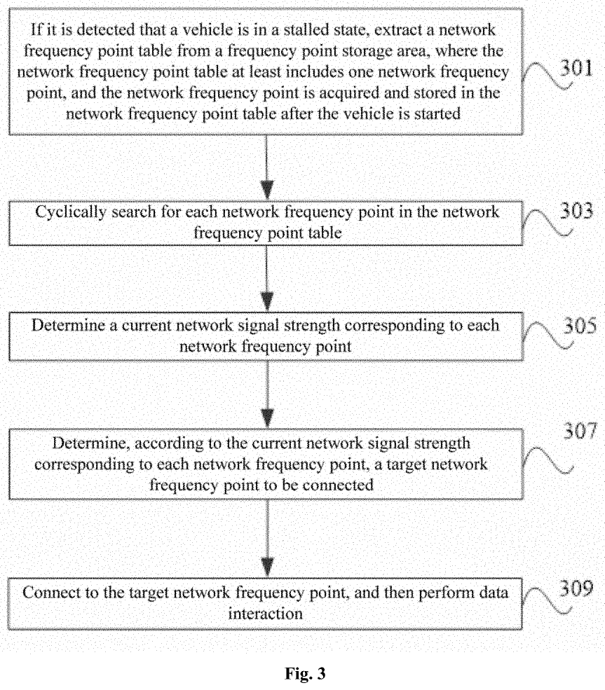

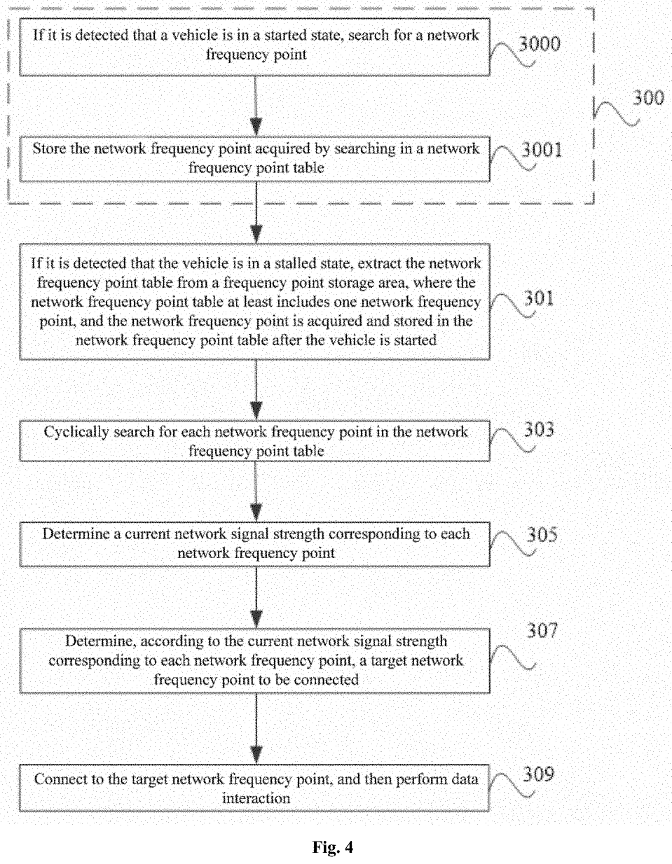

A specific embodiment of a network connection method according to the present application will be introduced below. FIG. 3 is a schematic flowchart of a network connection method provided by an embodiment of the present application. The specification provides operation steps of the method as described in the embodiments or the flowchart, but may include more or fewer operation steps based on conventional or uncreative labor. The sequence of steps listed in the embodiments is only one of many execution sequences of steps and does not represent the only execution sequence. In actual execution of a system or a server product, the steps may be executed sequentially or in parallel (for example, a parallel processor or multi-threaded processing environment) according to the methods shown in the embodiments or the accompanying drawings. As shown in FIG. 3 specifically, the method may include:

S301: if it is detected that a vehicle is in a stalled state, a network frequency point table is extracted from a frequency point storage area, where the network frequency point table at least includes one network frequency point, and the network frequency point is acquired and stored in the network frequency point table after the vehicle is started.

Optionally, the frequency point storage area is located in a storage unit of the vehicle, and if it is detected by a vehicle-mounted terminal that a vehicle is in a stalled state, the vehicle-mounted terminal may extract the network frequency point table from the frequency point storage area to provide the vehicle-mounted terminal with conditions for a network connection when the vehicle is stalled and parked.

In the embodiments of the present application, “after the vehicle is started” in step S301 may include any one of time periods from starting to stalling. Optionally, the network frequency point may be acquired when the vehicle is starting, when the vehicle is traveling, and when the vehicle is stopped but not stalled.

The network frequency point is acquired and stored in the network frequency point table after the vehicle is started, therefore, as shown in FIG. 4, in an optional implementation, the network connection method further includes a step of specifically storing the network frequency point in the network frequency point table.

S3000: if it is detected that the vehicle is in a started state, a network frequency point is searched.

Optionally, corresponding to the above content, a started state may include being in a starting state, a traveling state after starting, and a parking state after starting.

There is a certain distance between setting positions of each base station, and the base stations in a certain range near the vehicle keep switching after the vehicle is started, therefore, the vehicle-mounted terminal may search for the network frequency points when it is detected that the vehicle is in the started state to acquire the network frequency points corresponding to the base stations within a certain distance from the vehicle.

S3001: the network frequency point acquired by searching is stored in the network frequency point table.

For example, it is supposed that after the vehicle is started, three network frequency points 98, 99, and 100 of a base station A, one network frequency point 78 of a base station B, and two network frequency points 56 and 55 of a base station C are searched. The vehicle-mounted terminal may store the network frequency points 98, 99, 100, 78, 56, and 55 in the network frequency point table.

In an optional implementation, the vehicle-mounted terminal may store the network frequency point acquired by searching in the network frequency point table according to a time sequence. Based on the above example of three base stations, it is supposed that the vehicle-mounted terminal first searches for three network frequency points 98, 99, and 100 of the base station A; then one network frequency point 78 of the base station B; and finally two network frequency points 56 and 55. The vehicle-mounted terminal may store the network frequency points 98, 99, 100, 78, 56, and 55 into the network frequency point table in sequence to get the sequence of 55, 56, 78, 100, 99, 98 . . . , that is to say, the later a network frequency point is searched, the more preceding a storage position is.

However, if all the network frequency points searched during the vehicle traveling are stored in the network frequency point table, not only a large amount of storage space is wasted, but also some network frequency points, due to the distance, cannot contribute to a subsequent network connection. Therefore, to efficiently connect and save storage space during subsequent cyclical searching, in an optional implementation, the quantity of network frequency points in the network frequency point table is preset, for example, the quantity of network frequency points that can be stored in the network frequency point table is 10.

In the embodiments of the present application, the vehicle-mounted terminal, by combining with the limit of the quantity of the previous paragraph, may replace a historical network frequency point in the network frequency point table with the network frequency point acquired by searching according to a time sequence. For example, the network frequency point table has stored 10 historical network frequency points 1, 2, 3, 4, 5, 6, 7, 8, 9, and 10. When the network frequency points 98, 99, 100, 78, 56, and 55 are searched in sequence, the vehicle-mounted terminal will replace the historical network frequency points in the network frequency point table with the network frequency points acquired by searching according to a time sequence, thereby obtaining an updated network frequency point table in the sequence of 55, 56, 78, 100, 99, 98, 1, 2, 3 and 4 from the front to the back.

In another optional implementation, if a base station corresponds to a plurality of network frequency points, for example, the base station A in the above example, network signal strength corresponding to different network frequency points under the same base station is determined, and the network frequency points in the network frequency point table are sorted according to the network signal strength.

For example, the network signal strength of the network frequency point 98 under the base station A is greater than that of the network frequency point 99, and the network signal strength of the network frequency point 99 is greater than that of the network frequency point 100, so the network frequency point table in the sequence of 55, 56, 78, 100, 99, 98, 1, 2, 3 and 4 from the front to the back is updated again to 55, 56, 78, 98, 99, 100, 1, 2, 3 and 4 according to the network signal strength.

S303: each network frequency point in the network frequency point table is cyclically searched.

In an optional step that each network frequency point in the network frequency point table is cyclically searched, the vehicle-mounted terminal may cyclically search for each network frequency point in the network frequency point table according to a sequence of front to back. Optionally, the vehicle-mounted terminal may further cyclically search for each network frequency point in the network frequency point table according to a preset first time interval, for example, the first time interval is 10 seconds.

S305: a current network signal strength corresponding to each network frequency point is determined.

The vehicle-mounted terminal may determine a current network signal strength corresponding to each network frequency point. For example, when the current network signal strength is between −75 dBm and −85 dBm, it is indicated that the current network signal strength is relatively strong; when the current network signal strength is between −85 dBm and −95 dBm, it is indicated that the current network signal strength is not bad, and a specific reflection is that signal bars are not full; when the current network signal strength is between −100 dBm and −110 dBm, it is indicated that the current network signal strength is relatively weak; and when the current network signal strength is less than −110 dBm, it is basically considered no signal.

S307: a target network frequency point to be connected is determined according to the current network signal strength corresponding to each network frequency point.

In an optional implementation, the vehicle-mounted terminal may use the network frequency point with strongest network signal strength as the target network frequency point to be connected.

In another optional implementation, the vehicle-mounted terminal may set a signal strength threshold, and when the current network signal strength corresponding to some network frequency points in the network frequency point table is greater than the signal strength threshold, the vehicle-mounted terminal may select any one of these network frequency points as the target network frequency point to be connected.

S309: the target network frequency point is connected, and then data interaction is performed.

In another optional implementation, the vehicle-mounted terminal may set a signal strength threshold, and in the process of cyclically searching for each network frequency point in the network frequency point table, so long as the current network signal strength corresponding to one network frequency point is determined to be greater than or equal to the signal strength threshold, the network frequency point will be determined as the target network frequency point, and data interaction is performed on the network frequency corresponding to the target network frequency point.

The above descriptions are all based on being able to find a network frequency point for connection, thereby ensuring the normal progress of data interaction; however, in the embodiments of the present application, there is also a possibility that all the network frequency points cannot be searched, and therefore, if the vehicle-mounted terminal cannot search for each network frequency point in the network frequency point table, the next round of cyclical search for each network frequency point in the network frequency point table is started based on a preset second time interval. For example, the second time interval may be 10 minutes. Or, for example, the second time interval is an interval rule, which may be a gradient time interval, and if no network frequency point is searched in the first cyclical search, the vehicle-mounted terminal may start the next round of cyclical search at an interval of 10 minutes; if no network frequency point is searched in the second cyclical search, the vehicle-mounted terminal may start the next round of cyclical search at an interval of 20 minutes; if no network frequency point is searched in the third cyclical search, the vehicle-mounted terminal may start the next round of cyclical search at an interval of 40 minutes, and so on.

However, the place where the vehicle is stalled and parked may be far away from all the base stations, therefore, there is no possibility of a signal no matter how many times the network connection is performed, and in order to avoid performing an unlimited cyclical search in this case, a cycle number threshold may be set, and when the cycle number reaches the cycle number threshold, the cyclical search is stopped. In this way, energy consumption of the vehicle may be reduced.

Optionally, the place where the vehicle is stalled and parked may be far away from all the base stations, but there may be a new base station set up near the vehicle in the near future, therefore, the vehicle-mounted terminal may search for the network frequency point according to a preset third time interval to acquire a new network frequency point when the round number of the cyclical search reaches a preset round number.

In conclusion, in order that a vehicle owner may remotely monitor the vehicle by means of a mobile terminal to check a vehicle status or to perform data interaction with the vehicle to remotely control the vehicle, the vehicle-mounted terminal needs to perform data interaction with the base station. For such requirement, in the prior art, even if the vehicle is stalled and parked, the vehicle-mounted device still constantly searches for a near network frequency point, and searching for the network frequency point causes the current of the device to exceed 50 mA, while a static current of the whole vehicle designed is generally around 20 mA, which will directly lead to that the time of the vehicle-mounted terminal to maintain operating is directly halved or even shorter when the vehicle is parked.

However, in this application, considering that the number of base stations around the place where the vehicle is stalled and parked will not be adjusted in a short time period, if the network frequency point corresponding to the base station is stored in the network frequency point table, constant search may be avoided when the vehicle is parked, thereby saving power and prolonging the operating time of the vehicle-mounted terminal.

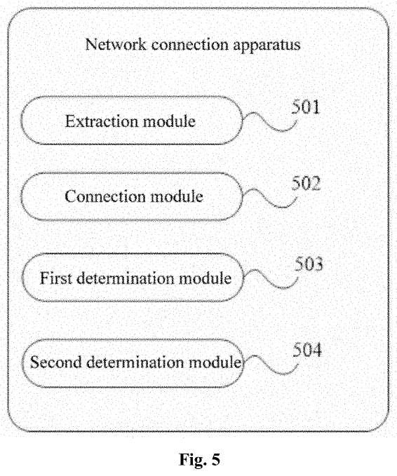

The embodiments of the present application further provide a network connection apparatus. FIG. 5 is a schematic structural diagram of a network connection apparatus according to an embodiment of the present application, and as shown in FIG. 5, the apparatus includes:

an extraction module 501, configured to extract a network frequency point table from a frequency point storage area if it is detected that a vehicle is in a stalled state, where the network frequency point table at least includes one network frequency point, and the network frequency point is acquired and stored in the network frequency point table after the vehicle is started;

a connection module 502, configured to cyclically search for each network frequency point in the network frequency point table;

a first determination module 503, configured to determine a current network signal strength corresponding to each network frequency point;

a second determination module 504, configured to determine, according to the current network signal strength corresponding to each network frequency point, a target network frequency point to be connected; and

the connection module 502, further configured to connect to the target network frequency point, and then perform data interaction.

In an optional implementation, the apparatus further includes: a searching module, configured to search for a network frequency point if it is detected that the vehicle is in a started state; and a storage module, configured to store the network frequency point acquired by searching in the network frequency point table.

In an optional implementation, the quantity of the network frequency point in the network frequency point table is preset; and the storage module is configured to replace a historical network frequency point in the network frequency point table with the network frequency point acquired by searching according to a time sequence.

In an optional implementation, the connection module is configured to cyclically search for each network frequency point in the network frequency point table according to a preset first time interval.

In an optional implementation, the connection module is configured to start the next round of cyclical search for each network frequency point in the network frequency point table based on a preset second time interval if each network frequency point in the network frequency point table cannot be searched.

In an optional implementation, the searching module is configured to search for the network frequency point according to a preset third time interval to acquire a new network frequency point if the round number of the cyclical search reaches a preset round number. The apparatus in the apparatus embodiments is based on the same application concept as the method embodiments.

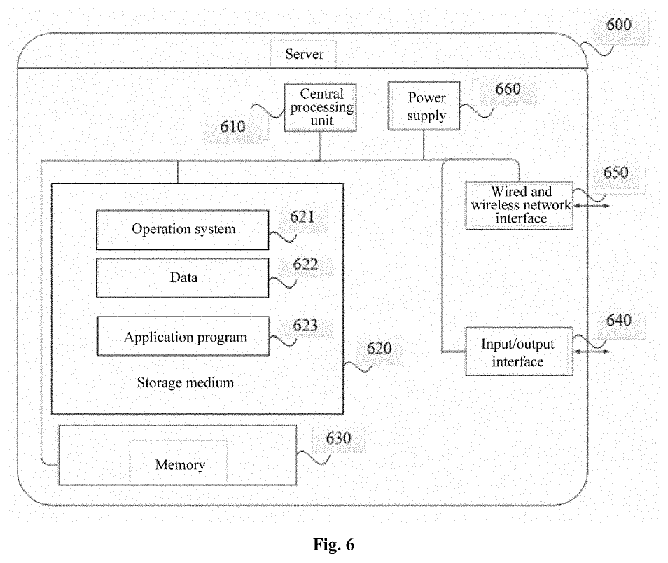

The method embodiments provided by the embodiments of the present application may be executed in a computer terminal, a server, or other similar operation apparatuses. For an example of operating on a server, FIG. 6 is a block diagram of a hardware structure of a server of the network connection method according to an embodiment of the present application. As shown in FIG. 6, this server 600 may vary relatively widely due to different configurations or performances and may include one or more central processing units (CPU) 610 (the processing unit 610 may include, but is not limited to, a processing device such as a microprocessor MCU or a programmable logic device FPGA), a memory 630 used to store data, and one or more storage media 620 used to store an application program 623 or data 622 (e.g., one or more mass storage devices). The memory 630 and the storage medium 620 may be transient storage or persistent storage. The program stored in the storage medium 620 may include one or more modules, each of which may include a series of instruction operations in the server. Further, the central processing unit 610 may be configured to communicate with the storage medium 620 to execute the series of instruction operations in the storage medium 620 on the server 600. The server 600 may also include one or more power supplies 660, one or more wired or wireless network interfaces 650, one or more input/output interfaces 640, and/or, one or more operation systems 621, such as Windows Server™, Mac OS X™, Unix™, Linux™, FreeBSD™ and the like.

The input/output interfaces 640 may be used to receive or transmit data via a network. The specific embodiment of the above-described network may include a wireless network provided by a communication provider of the server 600. In an embodiment, the input/output interface 640 includes a network interface controller (NIC) that can be connected to other network devices through a base station to communicate with the Internet. In an embodiment, the input/output interface 640 may be a radio frequency (RF) module configured to communicate wirelessly with the Internet.

It should be understood by those of ordinary skill in the art that the structure shown in FIG. 6 is merely schematic and does not limit the structure of the electronic device described above. For example, the server 600 may also include more or fewer components than that shown in FIG. 6, or have a different configuration from that shown in FIG. 6.

The embodiments of the present application further provide a storage medium. The storage medium may be arranged in the server to save at least one relevant instruction, at least one relevant program, a relevant code set or a relevant instruction set for implementing the network connection method in the method embodiments, and the at least one instruction, the at least one program, the code set or the instruction set is loaded and executed by the processor to implement the above network connection method.

Optionally, in this embodiment, the storage medium may be located at at least one network server among multiple network servers of a computer network. Optionally, in this embodiment, the storage medium may include, but not limited to: various media that may store program codes, such as a U disk, a read-only memory (ROM), a random access memory (RAM), a mobile hard disk, a magnetic disk, or an optical disk.

It can be seen from the embodiments of the network connection method, device or storage medium provided in the present application that in the present application, if it is detected that a vehicle is in a stalled state, a network frequency point table is extracted from a frequency point storage area, where the network frequency point table at least includes one network frequency point, and the network frequency point is acquired and stored in the network frequency point table after the vehicle is started; each network frequency point in the network frequency point table is cyclically searched; a current network signal strength corresponding to each network frequency point is determined; according to the current network signal strength corresponding to each network frequency point, a target network frequency point to be connected is determined; and the target network frequency point is connected, and then data interaction is performed. In this way, a device on the vehicle may be connected through the network frequency point stored in the network frequency point table, and the network frequency point is acquired during the vehicle traveling, therefore, when being parked, the vehicle does not need to consume more power to search for a new network frequency point again, thereby prolonging the operating time of the device when the vehicle is parked, such that a vehicle owner remotely monitors the vehicle by means of a mobile terminal.

It should be noted that the above sequence of embodiments of the present application is only for description, and does not represent the advantages or disadvantages of the embodiments. In addition, specific embodiments of this specification have been described above. Other embodiments are within the scope of the appended claims. In some cases, the actions or steps recited in the claims may be performed in a different order from those in the embodiments and still achieve desired results. In addition, the processes depicted in the accompanying drawings do not necessarily require the particular order or sequential order shown to achieve the desired results. In some implementations, multitask processing and parallel processing are possible or may be advantageous.

Embodiments in the specification are described in a progressive way, same and similar parts among the embodiments can refer to each other, and each embodiment focuses on differences from the other embodiments. In particular, for the device embodiments, which are substantially similar to the method embodiments, the descriptions are relatively simple, and where relevant, reference can be made to partial descriptions of the method embodiments.

Those of ordinary skill in the art can understand that all or part of the steps for implementing the above embodiments may be completed by hardware or by a program instructing related hardware, and the program may be stored in a computer-readable storage medium, which may be a read-only memory, a magnetic disk, or an optical disc, etc.

The above descriptions are only preferred embodiments of this application, and are not intended to limit this application. Any modifications, equivalent replacements, improvements etc. made within the spirit and principle of this application shall be included in the protection scope of this application.

1. A network connection method, comprising:
extracting a network frequency point table from a frequency point storage area if it is detected that a vehicle is in a stalled state, wherein the network frequency point table at least comprises one network frequency point, and the network frequency point is acquired and stored in the network frequency point table after the vehicle is started;
cyclically searching for each network frequency point in the network frequency point table;
determining a current network signal strength corresponding to each network frequency point;
determining, according to the current network signal strength corresponding to each network frequency point, a target network frequency point to be connected; and
connecting to the target network frequency point, and then performing data interaction.

2. The method according to claim 1, wherein, before extracting a network frequency point table from a frequency point storage area if it is detected that a vehicle is in a stalled state, the method further comprises:
searching for a network frequency point if it is detected that the vehicle is in a started state; and
storing the network frequency point acquired by searching in the network frequency point table.

3. The method according to claim 2, wherein the quantity of the network frequency point in the network frequency point table is preset; and
storing the network frequency point acquired by searching in the network frequency point table comprises:
replacing a historical network frequency point in the network frequency point table with the network frequency point acquired by searching according to a time sequence.

4. The method according to claim 1, wherein cyclically searching for each network frequency point in the network frequency point table comprises:
cyclically searching for each network frequency point in the network frequency point table according to a preset first time interval.

5. The method according to claim 4, wherein, after cyclically searching for each network frequency point in the network frequency point table, the method further comprises:
if each network frequency point in the network frequency point table cannot be searched, starting the next round of cyclical search for each network frequency point in the network frequency point table based on a preset second time interval.

6. The method according to claim 5, wherein the method further comprises:
if the round number of the cyclical search reaches a preset round number, searching for the network frequency point according to a preset third time interval to acquire a new network frequency point.

7-13. (canceled)

14. A computer-readable storage medium, wherein the storage medium stores at least one instruction, at least one program, a code set or an instruction set, wherein the at least one instruction, the at least one program, the code set or the instruction set is loaded and executed by a processor to implement the network connection method according to claim 1.

15. An electronic device, comprising a processor and a memory, wherein the memory stores at least one instruction, at least one program, and a code set or an instruction set, and the processor is configured to load and execute the at least one instruction, the at least one program, the code set or the instruction set to:
extract a network frequency point table from a frequency point storage area if it is detected that a vehicle is in a stalled state, wherein the network frequency point table at least comprises one network frequency point, and the network frequency point is acquired and stored in the network frequency point table after the vehicle is started;
cyclically search for each network frequency point in the network frequency point table;
determine a current network signal strength corresponding to each network frequency point;
determine, according to the current network signal strength corresponding to each network frequency point, a target network frequency point to be connected; and
connect to the target network frequency point, and then perform data interaction.

16. The electronic device according to claim 15, wherein the processor is further configured to:
search for a network frequency point if it is detected that the vehicle is in a started state; and
store the network frequency point acquired by searching in the network frequency point table.

17. The electronic device according to claim 16, wherein the quantity of the network frequency point in the network frequency point table is preset; and
the processor is further configured to replace a historical network frequency point in the network frequency point table with the network frequency point acquired by searching according to a time sequence.

18. The electronic device according to claim 15, wherein
the processor is further configured to cyclically search for each network frequency point in the network frequency point table according to a preset first time interval.

19. The electronic device according to claim 18, wherein
the processor is further configured to start the next round of cyclical search for each network frequency point in the network frequency point table based on a preset second time interval if each network frequency point in the network frequency point table cannot be searched.

20. The electronic device according to claim 19, wherein
the processor is further configured to search for the network frequency point according to a preset third time interval to acquire a new network frequency point if the round number of the cyclical search reaches a preset round number.
